(19) United States
(12) Patent Application Publication
(10) Pub. No.: US 2014/0292715 A1
(43) Pub. Date: Oct. 2, 2014

(54) SELF-CAPACITIVE TOUCH PANEL

(71) Applicant: MStar Semiconductor, Inc., Hsinchu Hsien (TW)

(72) Inventors: Tzu-Wei Liu, Zhubei City (TW); Xiao-Lin Luo, Zhubei City (TW); Hsien-Keng Lin, Zhubei City (TW)

(73) Assignee: MStar Semiconductor, Inc., Hsinchu Hsien (TW)

(21) Appl. No.: 14/242,951

(22) Filed: Apr. 2, 2014

(30) Foreign Application Priority Data
Apr. 2, 2013 (TW) 102111930

(51) Int. Cl. G06F 3/044

(52) U.S. Cl. CPC G06F 3/044
USPC 345/174

(57) ABSTRACT

A self-capacitive touch panel including two sensing regions is provided. Each of the sensing regions includes a first sensing channel, a second sensing channel, a border electrode and multiple central electrodes. The border electrode utilizes the first sensing channel exclusively. The central electrodes share the second sensing channel. The border electrode has a first centroid, which represents a position where a capacitance change contributed by the border electrode occurs. The central electrodes have a second centroid, which represents a position where a capacitance change contributed by the central electrode occurs. An average distance from the first centroid to all possible touch points in the border electrodes is shorter than an average distance from the second centroid to all possible touch points in the central electrodes.

This application claims the benefit of Taiwan application Serial No. 102111930, filed Apr. 2, 2013, the subject matter of which is incorporated herein by reference.

### BACKGROUND OF THE INVENTION

1. Field of the Invention

The invention relates in general to a touch control system, and more particularly, to a technology for enhancing the accuracy of sensing results of a border region of a touch panel.

2. Description of the Related Art

Operating interfaces of recent electronic products have become increasingly user-friendly and intuitive. For example, through a touch screen, a user can directly interact with applications as well as input messages/texts/patterns with fingers or a stylus, thus eliminating complexities associated with other input devices such as a keyboard or buttons. In practice, a touch screen usually comprises a touch panel and a display provided at the back of the touch panel. According to a touch position on the touch panel and a currently displayed image on the display, an electronic device determines an intention of the touch to execute corresponding operations.

Existing capacitive touch sensing techniques can be roughly categorized into self-capacitive and mutual-capacitive types. Compared to mutual-capacitive touch panels, self-capacitive touch panels can be implemented through a single-layer electrode with a simpler manufacturing process and lower costs, and thus prevail in many entry-level electronic products.

FIG. 1 shows an example of a self-capacitive touch panel. In a sensing region 100 represented by a dotted frame, a plurality of electrodes (e.g., electrodes 11, 12, 14, 15 and 17) each having a planar contour similar to a right triangle are disposed. Due to costly sensors that detect capacitance changes, in most current touch panels, multiple electrodes are designed to share one sensor to save costs. As shown in FIG. 1, the electrodes 11 and 12 are connected to a first upper sensor 13, and the electrodes 14 and 15 are connected to a first lower sensor 16. In other words, instead of the respective capacitance changes corresponding to the electrodes 11 and 12, the capacitance change detected by the first upper sensor 13 is a sum of the capacitance changes occurring at the electrodes 11 and 12. The capacitance changes detected by the 2*N number of sensors (an N number of upper sensors and an N number of lower sensors, each of which is numbered and serves as a i^{th} sensor, where i=1˜2N) are transmitted to a controller (not shown) for the controller to determine a user touch position. The controller calculates an x-coordinate of the user touch position in the X-direction according to the equation below:

$$x = \frac{{\sum }_{i = 1}^{2 N} ( {C}_{i} * {X}_{i} )}{{\sum }_{i = 1}^{2 N} {C}_{i}} \qquad equation ( 1 )$$

In equation (1), i is an integral index between 1 and 2N, Cᵢ represents a capacitance change detected by an i^{th} sensor, and Xᵢ represents an x-coordinate of a common centroid of electrodes connected the i^{th} sensor in the X-direction. Taking the first upper sensor 13 for example, the coordinate Xᵢ of the corresponding centroid (located between the electrodes 11 and 12) is the position of the common centroid of the two electrodes 11 and 12.

The touch panel in FIG. 1 faces a challenge of a remarkable error between sensing results of left and right border regions. Reasons behind such occurrence are described below with reference to FIGS. 2 and 3 again depicting the electrodes 11, 12, 14, 15 and 17 in FIG. 1.

When a user touch occurs at a position represented by a dotted circle 21 in FIG. 2, only the electrodes 11 and 14 are affected. Thus, a noticeable error is incurred from calculating the x-coordinate based on the capacitance change detected by the first upper sensor 13 and the first lower sensor 16. More specifically, although the capacitance change detected by the first upper sensor 13 mostly comes from the electrode 11, instead of the centroid of the electrode 11, the controller nonetheless regards a position (denoted as P1) of a common centroid of the electrodes 11 and 12 as the position at which the capacitance change detected by the first upper sensor 13 occurs. Similarly, although the capacitance change detected by the first lower sensor 16 mostly comes from the electrode 14, instead of the centroid of the electrode 14, the controller nonetheless regards a position (denoted as P2) of a common centroid of the electrodes 14 and 15 as the position at which the capacitance change detected by the first lower sensor 16 occurs. Consequently, the x-coordinate calculated is apparently shifted to the right of the actual position of the circle 21.

Referring to FIG. 3, assuming that the circle 21 is not located at a border position of the sensing region 100, a left half of the circle 21 theoretically triggers another electrode 31 (physically non-existent, represented by dotted lines), thus providing a capacitance change that shifts the x-coordinate to the left (closer to the actual X-coordinate of the circle 21 than the x-coordinate). In other words, in a border region, due to the lack of a balancing value possibly contributed by the virtual electrode 31 as well as great distances from the centroids P1 and P2 to the actual X-coordinate, the x-coordinate calculated by the controller may contain a remarkable error.

The above detection error at a border region much likely leads the controller to misjudge an intention of a user touch that further triggers an incorrect operation result. Yet, discarding the left and right borders of the sensing region 100 as a sacrifice for preventing the above issue, hardware costs are wasted.

### SUMMARY OF THE INVENTION

The invention is directed to a self-capacitive touch panel that generates a detection result having an enhanced accuracy through changing a centroid position corresponding to a sensor of a border region.

According to an embodiment of the present invention, a self-capacitive touch panel including two sensing regions is provided. Each of the sensing regions includes a first sensing channel, a second sensing channel, a border electrode and a plurality of central electrodes. The first sensing channel is connected to the first sensor. The second sensing channel is connected to a second sensor. The border electrode exclusively utilizes the first sensing channel, and has a planar contour similar to a right triangle. The central electrodes share the second sensing channel, and have planar contours similar to the right triangle. The border electrode has a first centroid, which represents a position at which a capacitance change contributed by the border electrode occurs. The central electrodes have a second centroid, which represents a position at which a capacitance change contributed by the central electrodes occurs. A first average distance from the first centroid to all possible touch points in the border electrode is smaller than a second average distance from the second centroid to all possible touch points in the central electrodes.

According to another embodiment of the present invention, a self-capacitance touch panel including two sensing regions is provided. Each of the sensing regions includes a first sensing channel, a second sensing channel, a plurality of border electrodes and a plurality of central electrodes. The first sensing channel is connected to the first sensor. The second sensing channel is connected to a second sensor. The border electrodes share the first sensing channel, and have planar contours similar to a first right triangle. The central electrodes share the second sensing channel, and have planar contours similar to a second right triangle. The border electrodes have a first centroid, which represents a position at which a capacitance change contributed by the border electrodes occurs. The central electrodes have a second centroid, which represents a position at which a capacitance change contributed by the central electrodes occurs. A first average distance from the first centroid to all possible touch points in the border electrodes is smaller than a second average distance from the second centroid to all possible touch points in the central electrodes.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is an example of a conventional self-capacitive touch panel;

FIGS. 2 and 3 illustrate reasons causing remarkable sensing errors at border regions of a conventional self-capacitive touch panel;

FIG. 4 is a schematic diagram of an electrode arrangement according to an embodiment of the present invention; FIG. 5 illustrates reasons why the embodiment is capable of enhancing the positioning accuracy;

FIG. 6 is a schematic diagram of an electrode arrangement according to another embodiment of the present invention; FIG. 7 illustrates reasons why the embodiment is capable of enhancing the positioning accuracy;

FIG. 8 is a schematic diagram of an electrode arrangement according to another embodiment of the present invention; and

FIG. 9 is a schematic diagram of electrode/sensing channel arrangement according to another embodiment of the present invention.

### DETAILED DESCRIPTION OF THE INVENTION

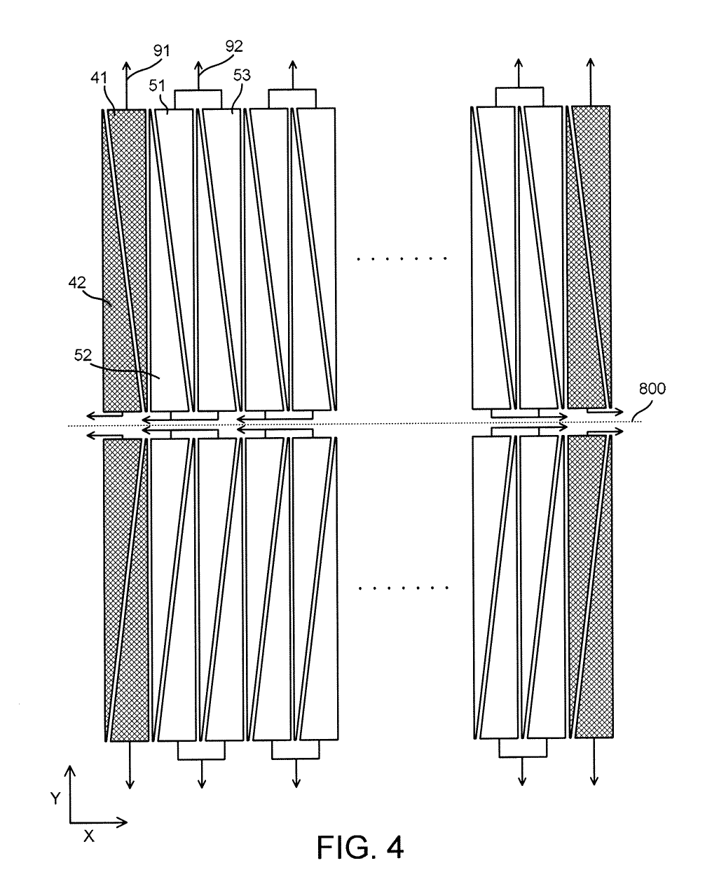

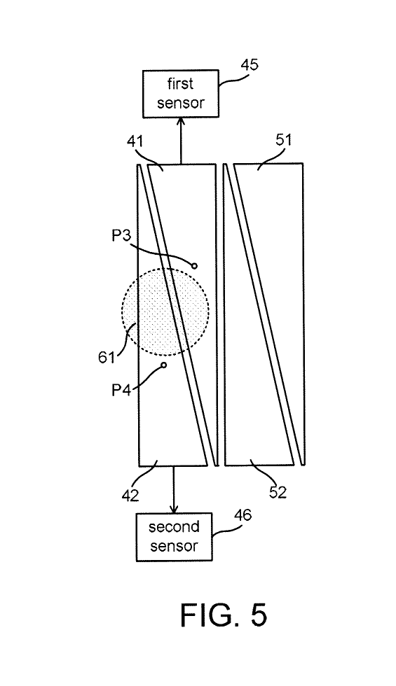

A self-capacitance touch panel is provided by an embodiment of the present invention. The self-capacitance touch panel has an electrode arrangement as shown in FIG. 4. Taking a virtual reference line 800 as a boundary, the electrodes each having a planar contour as a right triangle may be divided into upper and lower groups along the Y-direction to form to two different sensing regions. In the embodiment, the shaded electrodes at the left and right sides are defined as border electrodes (e.g., electrodes 41 and 42), and other non-shaded electrodes are defined as central electrodes (e.g., electrodes 51 and 52). In the embodiment, the border electrodes and the central electrodes are substantially equal in width. As seen from FIG. 4, each of the border electrodes utilizes one sensing channel (e.g., the electrode 41 utilizes a sensing channel 91 exclusively), i.e., each of the border electrodes is connected to a dedicated sensor (not shown) that senses a capacitance change. In contrast, every two central electrodes share one sensing channel (e.g., the electrodes 51 and 53 share a sensing channel 92) and are connected to the same sensor (not shown). In practice, the self-capacitance touch panel further includes a controller that determines a touch position according to detection results of the sensors.

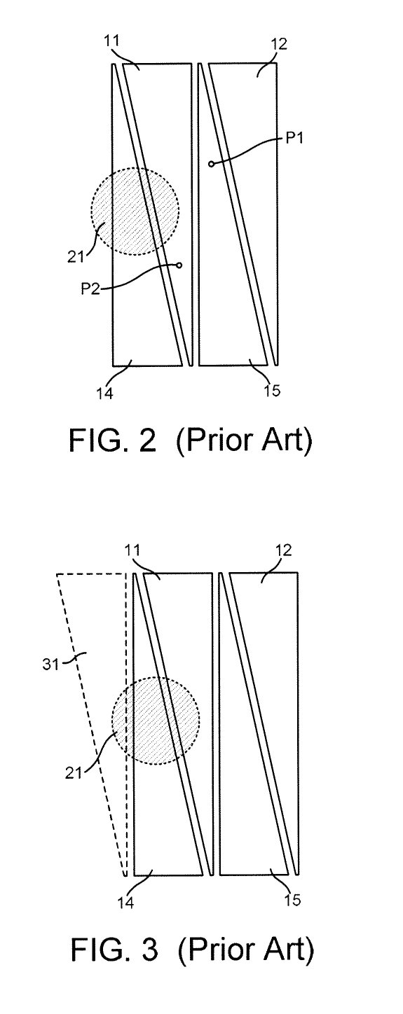

To explain reasons why the accuracy of detection results of electrodes arranged at border regions of the embodiment excels the conventional solution, the electrodes 41, 42, 51 and 52 in FIG. 4 are re-drawn in FIG. 5. FIG. 5 also depicts a first sensor 45 that detects a capacitance change of the electrode 41 and a second sensor 46 that detects a capacitance change of the electrode 42. For a simpler comparison, in practice, for example, it is assumed that the electrodes 41, 42, 51 and 52 and the electrode 11 in FIG. 2 are equal in width along the X-direction.

When a user touch occurs at a position represented by a dotted circle 61 in FIG. 5, the electrodes 41 and 42 are affected. The capacitance changes detected by the first sensor 45 and the second sensor 46 are a basis for calculating coordinates of a touch point. As the first sensor 45 is connected to only the electrode 41, when determining an X-coordinate of a touch point according to equation (1), the controller utilizes a centroid (denoted as P3) of the electrode 41 to represent a position at which the capacitance change detected by the first sensor 45 occurs. Similarly, a centroid (denoted as P4) of the electrode 42 is utilized to represent a position at which the capacitance change detected by the second sensor 46 occurs. As seen from FIG. 5, along the X-direction, the centroids P3 and P4 are quite close to a center of the circle 61. It is understood that, compared to the circumstances shown in FIG. 2, the x-coordinate calculated by the controller in the embodiment is closer to the actual X-coordinate of the circle 61. More specifically, as the centroids that the controller considers for calculating the x-coordinate are in average closer to the position of the electrode where the capacitance change actually occurs, the x-coordinate provided by the electrode/sensor arrangement in FIG. 4 has a higher accuracy.

Comparing the electrode 41 in FIG. 5 with the electrodes 11 and 12 in FIG. 2, an average distance from the centroid P3 to all possible touch points in the electrode 41 is apparently shorter than an average distance from the centroid P1 to all possible touch points in the electrodes 11 and 12. Therefore, in average, compared to representing the capacitance change that the first upper sensor 13 detects by the X-coordinate of the centroid P1, representing the capacitance change that the first sensor 43 detects by the X-coordinate of the centroid P3 more precisely reflects the actual touch position. Similarly, the other border electrodes in FIG. 4 are also capable of achieving the same effect.

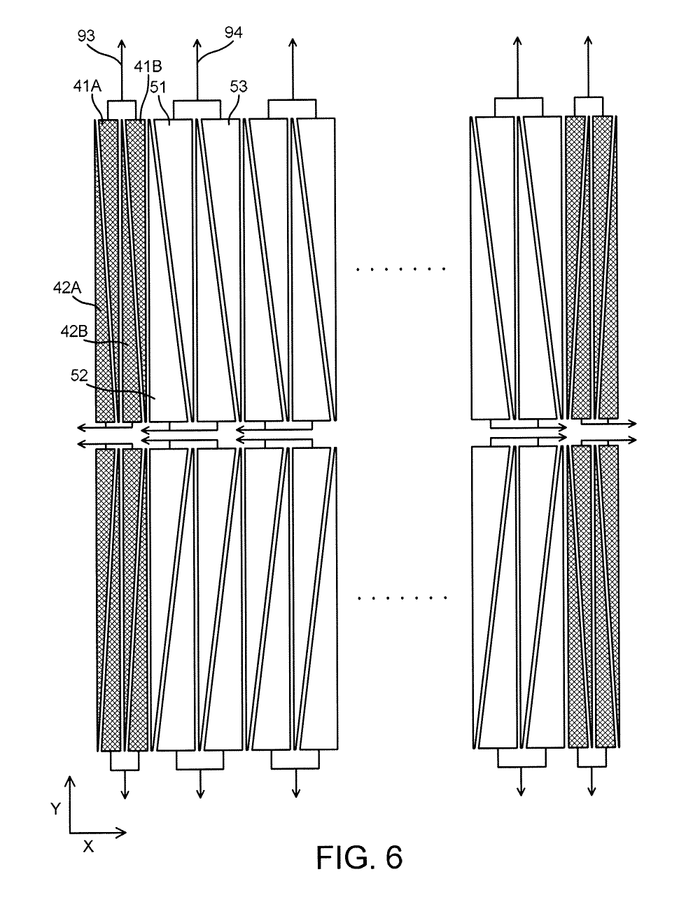

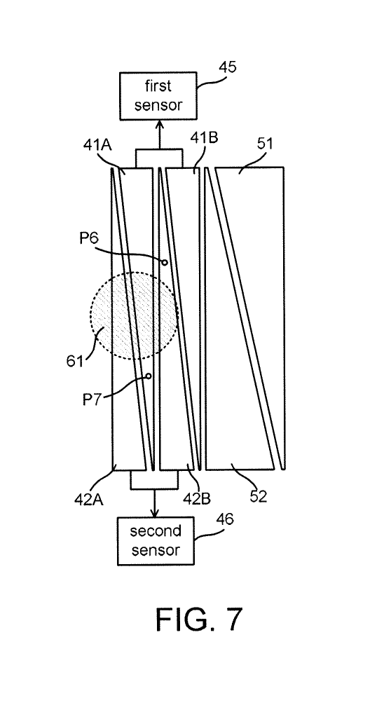

FIG. 6 shows an electrode arrangement of a self-capacitance touch panel according to another embodiment of the present invention. In the embodiment, electrodes each having a planar contour similar to a right triangle are also divided into upper and lower groups along the Y-direction to form two different sensing regions. It should be noted that, in the embodiment, border electrodes are narrower than central electrodes in width along the X-direction. Further, for both the border electrodes and central electrodes, every two electrodes share one sensing channel. For example, border electrodes 41A and 41B share a sensing channel 93, and central electrodes 51 and 53 share a sensing channel 94.

To explain reasons why the accuracy of detection results of electrodes arranged at border regions of the embodiment excels the conventional solution, the electrodes 41A, 41B, 42A, 42B, 51 and 52 in FIG. 6 are re-drawn in FIG. 7. FIG. 7 also depicts a first sensor 45 that detects capacitance changes of the electrodes 41A and 41B, and a second sensor 46 that detects capacitance changes of the electrodes 42A and 42B. For a simpler comparison, in practice, for example, it is assumed that the electrodes 51 and 52 and the electrode 11 in FIG. 2 are substantially equal in width along the X-direction.

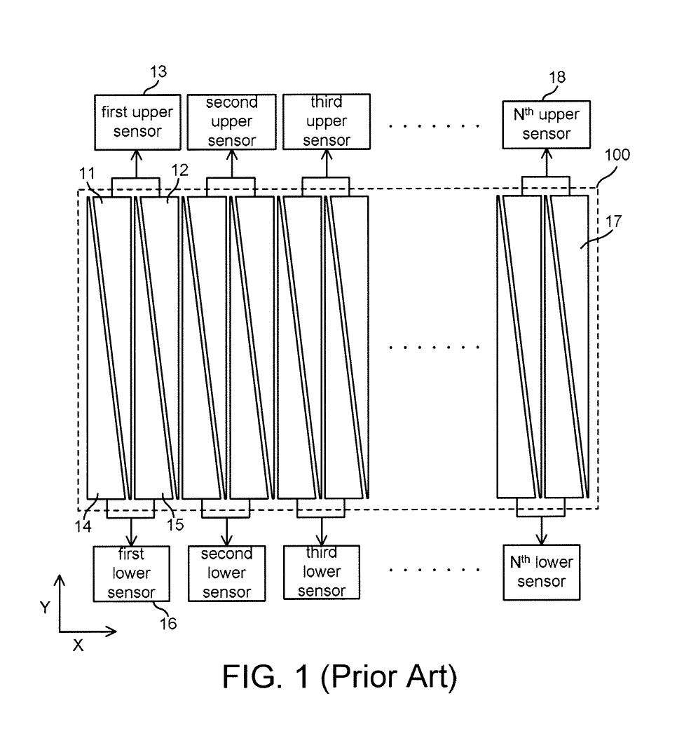

When a user touch occurs at a position represented by a dotted circle 61 in FIG. 7, the electrodes 41A, 42A and 42B are affected. Thus, the capacitance changes detected by the first sensor 45 and the second sensor 46 are utilized for calculating coordinates of the touch point. When determining the X-coordinate of the touch point according to equation (1), the controller utilizes a common centroid (denoted as P6) of the electrodes 41A and 41B to represent the position at which the capacitance change detected by the first sensor 45 occurs, and utilizes a common centroid (denoted as P7) of the electrodes 42A and 42B to represent the position at which the capacitance change detected by the second sensor 46 occurs. Compared to the X-coordinates of the centroids P1 and P2 that represent the capacitance change in FIG. 2, the X-coordinates of the centroids P6 and P7 that represent the capacitance change in the embodiment are closer to the actual X-coordinate of the circle 61. It is concluded that, compared to the electrode/sensor arrangement in FIG. 1, the electrode/sensor arrangement in FIG. 6 provides an x-coordinate with a higher accuracy. Similarly, the other border electrodes are also capable of achieving the same effect. One skilled person in the art can easily appreciate that the quantity of the electrodes that share the same sensor is not limited to the exemplary quantity of two in the embodiment.

It should be noted that, in the above embodiments, the electrodes at the upper and lower sensing regions having the same arrangement are given as an example to explain the present invention, not to limit present invention. For example, the upper sensing region may include the border electrodes shown in FIG. 4, and the lower sensing region may include the border electrodes shown in FIG. 6. Given the above conditions for designing the centroids, the planar contour of the electrodes is not limited to a right triangle.

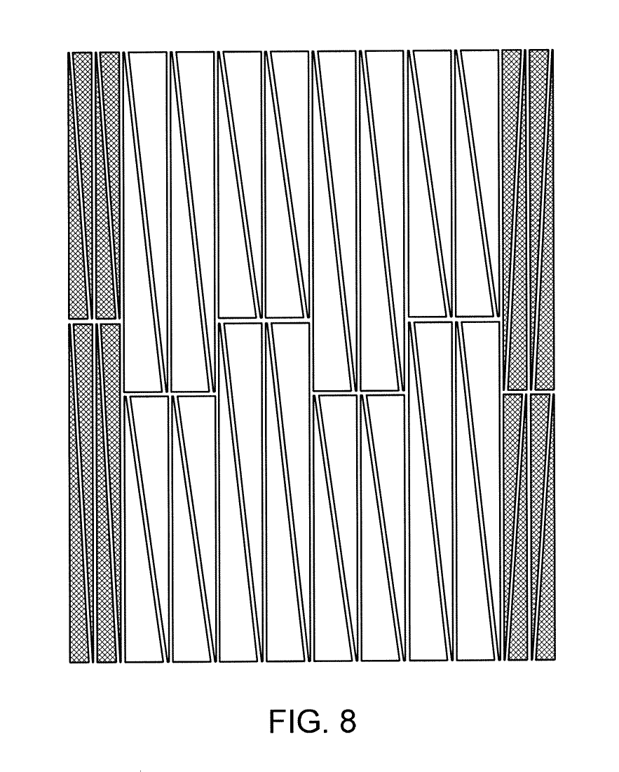

FIG. 8 shows an electrode arrangement of a self-capacitive touch panel further provided according to another embodiment of the present invention. In the embodiment, a region boundary separating upper and lower sensing regions is a non-linear line parallel to the X-direction. As shown in FIG. 8, second shortest sides of the border electrodes and the central electrodes parallel to the Y-direction are not equal in length, and not all of the second shortest sides of all the border electrodes are equal in length. One person skilled in the art can easily appreciate that, the arrangement of the border electrodes in the embodiment, similar to the electrode arrangement in FIG. 6, is also capable of improving the accuracy of sensing results.

As demonstrated by the above embodiments, a main spirit of the present invention is to generate a more accurate x-coordinate than the conventional solution by changing a centroid corresponding to a sensor of a border region. Taking FIG. 4 for example, an average distance from the centroid of the border electrode 41 to all possible touch points in the border electrodes 41 is designed to be shorter than an average distance from the common centroid of the central electrodes 51 and 53 to all possible touch points in the central electrodes 51 and 53. Taking FIG. 6 for example, an average distance from the common centroid of the border electrodes 41A and 41B to all possible touch points in the border electrodes 41A and 41B is designed to be shorter than an average distance from the common centroid of the central electrodes 51 and 53 to all possible touch points in the central electrodes 51 and 53.

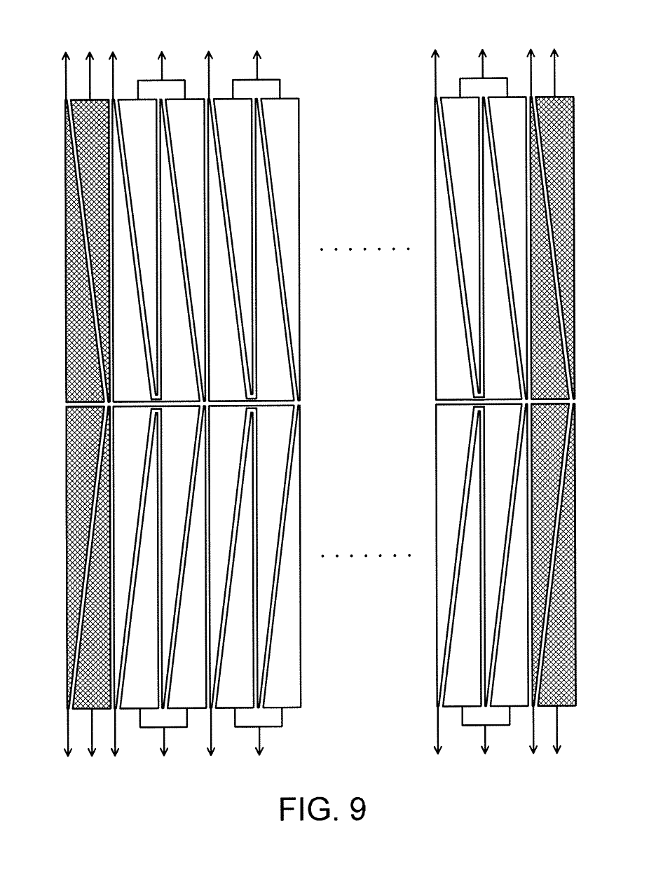

It can be understood that, the application of the concept of the present invention is not limited to the foregoing exemplary electrode shapes, electrode arrangements and sensor arrangements. For example, each of the central electrodes in FIG. 4 is individually connected to one sensor (i.e., no sensor is to be shared). Under such circumstances, since the average distance from the centroid of the border electrode 41 to all possible touch points in the border electrode 41 is still shorter than the average distance from the centroid of the central electrode 51 to all possible points at the central electrode 51, an x-coordinate having a higher accuracy can be similarly obtained. For another example, a wire arrangement of the sensing channels is as shown in FIG. 9, with the wires guided from an uppermost or lowermost end to the exterior instead of going through a gap between the two sensing regions. As shown in FIG. 9, a part of the electrodes that share sensing channels/sensors are directly connected to one another without wires in between.

Further, in one embodiment, planar contours of an N number of first border electrodes (e.g., 41, 42, 41A, 41 B, 42A and 42B, where N is a positive integer) are similar to a first right triangle, planar contours of an M number of first central electrodes (e.g., 51, 52 and 53, where M is a positive integer) are similar to a second right triangle, planar contours of a P number of second border electrodes (the lower border electrodes in FIG. 4, FIG. 6, FIG. 8 and FIG. 9, where P is a positive integer) are similar to a third right triangle, and planar contours of a Q number of second central electrodes (the lower central electrodes in FIG. 4, FIG. 6, FIG. 8 and FIG. 9, where Q is a positive integer) are similar to a fourth right triangle. A shortest side of each of the first border electrodes, the first central electrodes, the second border electrodes and the second central electrodes are parallel to the same reference direction.

A longer leg (i.e. a second shortest side) of the first right triangle has a first length, a longer leg of the second right triangle has a second length, a longer leg of the third right triangle has a third length, and a longer leg of the fourth right triangle has a fourth length. A sum of the first length and the third length is substantially equal to a sum of the second length and the fourth length.

The positive integer N is equal to the positive integer M, and the first right triangle is smaller than the second right triangle. Alternatively, the positive integer N is smaller than the positive integer M, and the first right triangle is the same as the second right triangle.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A self-capacitive touch panel, comprising:
two sensing regions, each comprising:
a first sensing channel, connected to the first sensor;
a second sensing channel, connected to the second sensor;
a border electrode, exclusively utilizing the first channel, having a planar contour similar to a predetermined polygon, the border electrode further having a first centroid that represents a position at which a capacitance change contributed by the border electrode occurs; and
a plurality of central electrodes, sharing the second sensing channel, each having a planar contour similar to the predetermined polygon, the central electrodes further having a second centroid that represents a position at which a capacitance change contributed by the central electrodes occurs;
wherein, a first average distance from the first centroid to all possible touch points in the border electrode is shorter than a second average distance from the second centroid to all possible touch points in the central electrodes, and the predetermined polygon tapers along a reference direction.

2. A self-capacitive touch panel, comprising:
two sensing regions, each comprising:
a first sensing channel, connected to the first sensor;
a second sensing channel, connected to the second sensor;
a plurality of border electrodes, sharing the first channel, each having a planar contour similar to a first right triangle, the border electrodes further having a first centroid that represents a position at which a capacitance change contributed by the border electrodes occurs; and
a plurality of central electrodes, sharing the second sensing channel, each having a planar contour similar to a second right triangle, the central electrodes further having a second centroid that represents a position at which a capacitance change contributed by the central electrodes occurs;
wherein, a first average distance from the first centroid to all possible touch points in the border electrodes is shorter than a second average distance from the second centroid to all possible touch points in the central electrodes.

3. A self-capacitive touch panel, comprising:
a first sensing region, comprising:
a first sensing channel;
a second sensing channel;
an N number of first border electrodes, connected to the first sensing channel, having a first centroid that represents a position at which a capacitance change contributed by the N number of first border electrodes occurs, N being a positive integer; and
an M number of first central electrodes, connected to the second sensing channel, having a second centroid that represents a position at which a capacitance change contributed by the M number of first central electrodes occurs, M being a positive integer; and
a second sensing region, comprising:
a third sensing channel;
a fourth sensing channel;
a P number of second border electrodes, connected to the third sensing channel, having a third centroid that represents a position at which a capacitance change contributed by the P number of second border electrodes occurs, P being a positive integer; and
a Q number of second central electrodes, connected to the fourth sensing channel, having a fourth centroid that represents a position at which a capacitance change contributed by the Q number of second central electrodes occurs, Q being a positive integer;
wherein, a first average distance from the first centroid to all possible touch points in the N number of first border electrodes is shorter than a second average distance from the second centroid to all possible touch points in the M number of first central electrodes; a third average distance from the third centroid to all possible touch points in the P number of second border electrodes is shorter than a fourth average distance from the fourth centroid to all possible touch points in the Q number of second central electrodes.

4. The self-capacitive touch panel according to claim 3, wherein a planar contour of each of the first border electrodes is similar to a first right triangle, a planar contour of each of the first central electrodes is similar to a second right triangle, a planar contour of each of the second border electrodes is similar to a third right triangle, and a planar contour of each of the second central electrodes is similar to a fourth right triangle; a shortest side of each of the first border electrodes, each of the first central electrodes, each of the second border electrodes and each of the second central electrodes are parallel to a same reference direction.

5. The self-capacitive touch panel according to claim 4, wherein a longer leg of the first right triangle has a first length, a longer leg of the second right triangle has a second length, a longer leg of the third right triangle has a third length, and a longer leg of the fourth right triangle has a fourth length; a sum of the first length and the third length is substantially equal to a sum of the second length and the fourth length.

6. The self-capacitive touch panel according to claim 4, wherein the positive integer N is equal to the positive integer M, and the first right triangle is smaller than the second right triangle.

7. The self-capacitive touch panel according to claim 4, wherein the positive integer N is smaller than the positive integer, and the first right triangle is same as the second right triangle.
